(19) United States
(12) Patent Application Publication
(10) Pub. No.: US 2002/0161891 A1
(43) Pub. Date: Oct. 31, 2002

(54) System and method for computer resource marketing

(76) Inventors: Tatsuo Higuchi, Fuchu (JP); Shinichi Kawamoto, Hachioji (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/046,482

(22) Filed: Jan. 16, 2002

(30) Foreign Application Priority Data
Apr. 25, 2001 (JP) 2001-127208

(51) Int. Cl. G06F 15/173; G06F 9/00

(52) U.S. Cl. 709/226; 709/104

(57) ABSTRACT

A computer resource marketing system using LPAR (logical partitioning) technology that divides a computer resource into a plurality of logical partitions, including a lending server with a logical partition control unit 3 that designates at least one logical partition as a lendable partition, a client system that can borrow a logical partition in the lending server and submit processing to the logical partition, a resource database that stores lending conditions and certification information of logical partitions in the lending server, and a management server that searches the resource database based on a borrowing request from a client system, notifies the client system of a logical partition that meets the requirements of the borrowing request, and authorizes the client system to use the logical partition.

### BACKGROUND OF THE INVENTION

1. Field of the Invention

The present invention relates to a computer system in which the resources are shared among a plurality of computers interconnected through a network.

2. Prior Art

There is a known technology that divides one physical computer resource into logical partitions and uses them as a plurality of virtual computers, as disclosed, for example, in patent documents JP-A-103092/1994 and U.S. Pat. No. 5,659,786. Specific implementations of this technology are known by such names as hypervisor and LPAR (logical partition).

With recent penetration of the Internet and intranets and a quantum leap in performance of personal computers, a type of technology for sharing or lending resources among a plurality of networked computers has been proposed. Known as peer-to-peer computing, this technology lends available computer resources by the hour and uses the partial resources of a plurality of personal computers to carry out processing that has conventionally been executed by supercomputers.

This technology, as shown in FIG. 17, preinstalls a lending resource manager (resource management software) 91 on a lending computer 90. A client that shares the resources of the computer 90 uses hardware 100 comprising a CPU, memory, and a disk drive via the resource manager 91 and an operating system (referred to as OS below) 92 to submit a job (client application 93) for execution.

The example shown in FIG. 17, however, presents a problem in that the resource manager 91 installed on the computer 90 for lending resources is implemented as an application running on the shared OS 92 or as a built-in function of the OS 92, so if the OS 92 stops (hangs up) under the influence of a lender's application 94 running on the computer 90, resource lending services stop, resulting in poor service quality and performance.

Another problem, from the viewpoint of the lender (such as the owner) of the resources of the computer 90 is that the lender's application 94 may also stop if the OS 92 is hung up by the client application 93 running on a lent resource, and if a computer virus or worm is present in the client application 93, it may destroy data in the computer 90 lending the resource, or impair security such as by allowing data to leak.

The former example of the prior art (disclosed in JP-A-103092/1994 and U.S. Pat. No. 5,659,786) has another problem in that although it can allocate logical partitions for lending, the resources allocated to the logical partitions can be changed while they are being lent, so it is difficult to offer assured performance to the users.

### SUMMARY OF THE INVENTION

An object of the present invention is to provide improved processing capability and fault tolerance, to assure the quality of lent resources, and to provide adequate security for both lender and borrower, thereby making resource sharing more reliable.

Other objects of the present invention will become apparent in the description of the embodiments of the invention.

A computer resource marketing system according to the present invention comprises a computer with a logical partition control means for dividing resources of the computer into a plurality of logical partitions and designating at least one logical partition as lendable; a client system that can submit job to the computer; a resource database storing lending conditions and certification information of the logical partitions of the computer; and a management means that searches the resource database according to use requirements (borrowing requirements) defined by the client system, finds a logical partition that meets the use requirements, notifies the client system of the logical partition found by the search, and grants the client system permission to use the logical partition.

The logical partition control means comprises a means for storing allocation information indicating resources that have been allocated to the computer for lending to a client system, an altering means for changing logical partitions according to the allocation information, and a locking means for disabling change of the logical partition at least while the client is using it, and, in a more preferable configuration, comprises a plurality of computers (logical partitions) in which different operating systems are bootable.

As described above, in a computer resource marketing system according to the present invention, in order to borrow one of a plurality of logical partitions generated in a computer, a client system sends use requirements to a management means that manages the lendable resources, and the management means references the resource database to determine the logical partition to be lent, whereby the client system on the borrowing side can quickly find resources that meet the use requirements and are available, and, in peer-to-peer computing that shares resources among a plurality of computers, quick acquisition of required performance and OSs is possible, enabling the lending side to ensure processing capability, fault tolerance, and security by using logical partitions.

### BRIEF DESCRIPTION OF THE DRAWINGS

In the attached drawings:

FIG. 1 is a schematic block diagram of a resource marketing system according to a first embodiment of the present invention;

FIG. 2 is a schematic representation of the data structure of an exemplary logical partition database of a lending server;

FIG. 3 is a schematic representation of the data structure of an exemplary resource database of a management server;

FIG. 4 is a schematic representation showing the main data flow in a resource marketing system;

FIG. 5 is a flow diagram showing an example of logical partition generation processing executed by a lending server;

FIG. 6 is a flow diagram showing an example of the process of registering a lendable logical partition in a management server;

FIG. 7 is a flow diagram showing an example of the process of changing the allocated resources of a lendable logical partition;

FIG. 8 is a flow diagram of an example of processes performed in a management server and a client system when a borrowing request is made by the client system;

FIG. 9 is a flow diagram of an example of processes executed by a client system to borrow the resources of a lending server;

FIG. 10 is a schematic representation showing the data structure of a logical partition database in a second embodiment;

FIG. 11 shows schematically how the resources of one lending server are managed by a plurality of management servers;

FIG. 12 is a flow diagram showing an example of a process executed in a lending server to generate logical partitions;

FIG. 13 is a flow diagram showing an example of a process of registering a lendable logical partition in a management server;

FIG. 14 is a flow diagram showing an example of a process of changing the allocated resources of a lendable logical partition;

FIG. 15 is a flow diagram showing an example of a process for the borrowing of resources of a lending server by a client system;

FIG. 16 is a schematic representation of a resource marketing system in a third embodiment of the present invention; and

FIG. 17 is a schematic diagram showing the prior art.

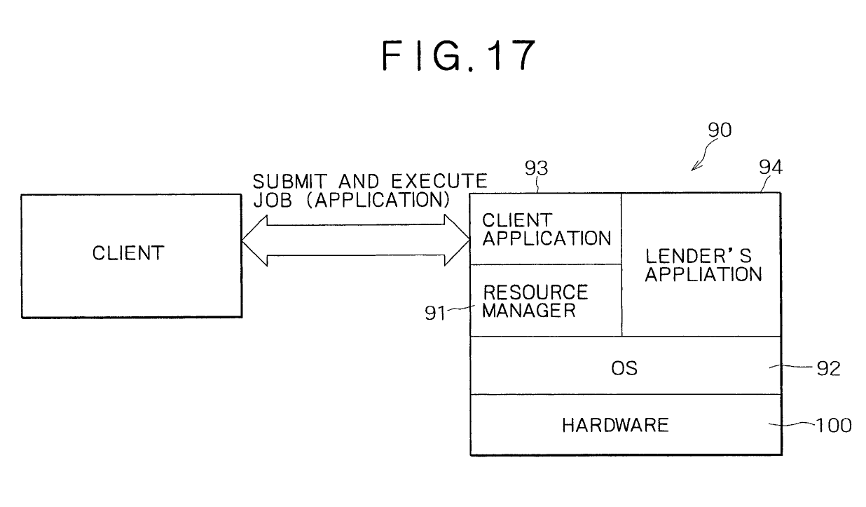

### DETAILED DESCRIPTION OF THE PREFERRED EMBODIMENTS

Embodiments of the invention will be described with reference to the attached drawings.

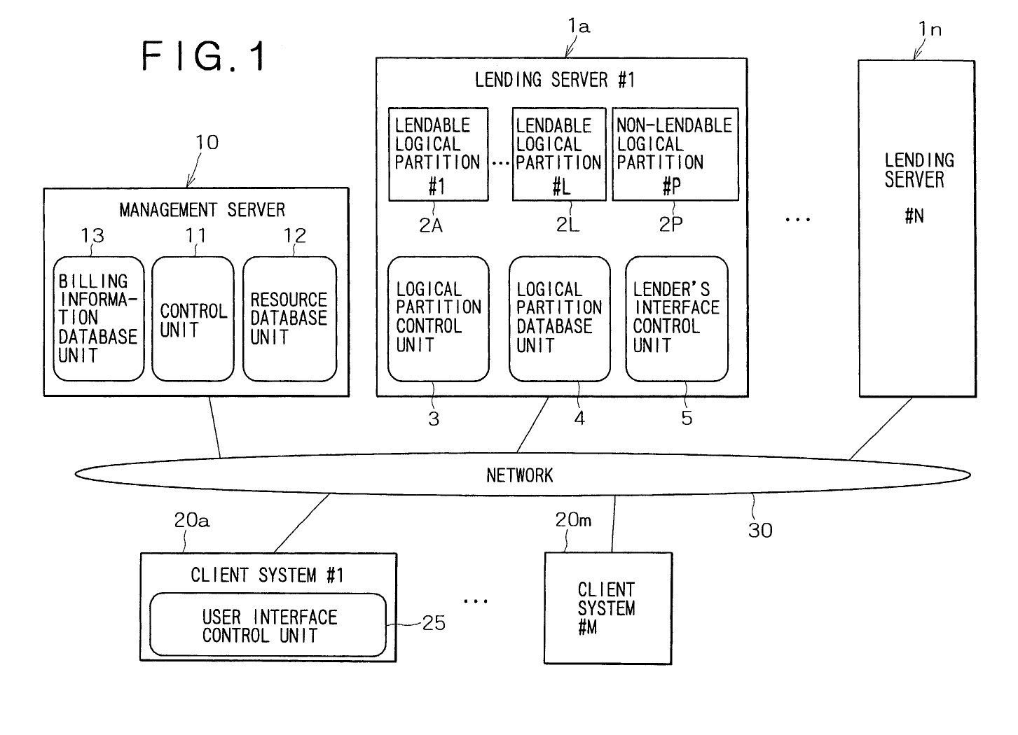

FIG. 1 shows an exemplary structure of a computer system suitable for an embodiment of the present invention, comprising a plurality of lending servers (computers) 1a to in that provide computer resources (simply referred to as resources below), a plurality of client systems (computers) 20a to 20m that use resources provided by the plurality of lending servers 1a to in, and a management server (management means) 10 that manages resources of the plurality of lending servers 1a to 1n on the provider side, searches among the plurality of lending servers 1a to in for lending servers available to the plurality of client systems 20a to 20m and notifies the client systems 20a to 20m, which are attached to a network 30, of the search result, thereby forming a computer resource marketing system.

1. System configuration

The lending servers 1a to in each comprise a logical partition control unit 3 that divides one physical resource into a plurality of logical partitions, and controls and manages the plurality of logical partitions, a logical partition management database 4 that stores the status (conditions, performance, and other properties) and operating conditions (lending conditions) of resources of the logical partitions, and a lender's interface control unit 5 that controls submission of jobs to lendable logical partitions, in which the jobs run.

The lending servers 1a to in are configured similarly, so the following description will be confined to the lending server 1a; the client systems 20a to 20m used as user systems are configured similarly, so the following description will focus on the client system 20a.

The logical partition control unit 3 divides a physical resource of the lending server 1a into a plurality of logical resources based on information in the logical partition management database 4, assumes them to be the logical partitions, and allows an arbitrary OS (operating system) to start running on each of the logical partitions.

As in the technology disclosed by JP-A-103092/1994 and JP-A-295841/1995, the logical partition control unit 3 divides one physical computer resource into a plurality of logical partitions (virtual computers) and allows each of the logical partitions to function as an independent virtual computer.

In addition, the logical partition control unit 3 controls the plurality of logical partitions by separating them into lending partitions 2A to 2L that are provided to the client system 20a and a non-lendable logical partition 2P. There may be only one lending partition, or there may be a plurality of non-lendable logical partitions.

The logical partition control unit 3 ensures the performance (resource bandwidth) of the lendable logical partitions 2A to 2L, references the logical partition management database 4 and the management server 10 to authenticate the client system 20a to which a logical partition is provided, and, as described later, and ensures the performance to be provided by locking the logical partition while it is being lent to prevent changes of allocated resources. Ensuring performance means ensuring the processing capability of CPUs allocated to a lending partition (the number of CPUs or percentage of their time), and ensuring memory space and hard disk space.

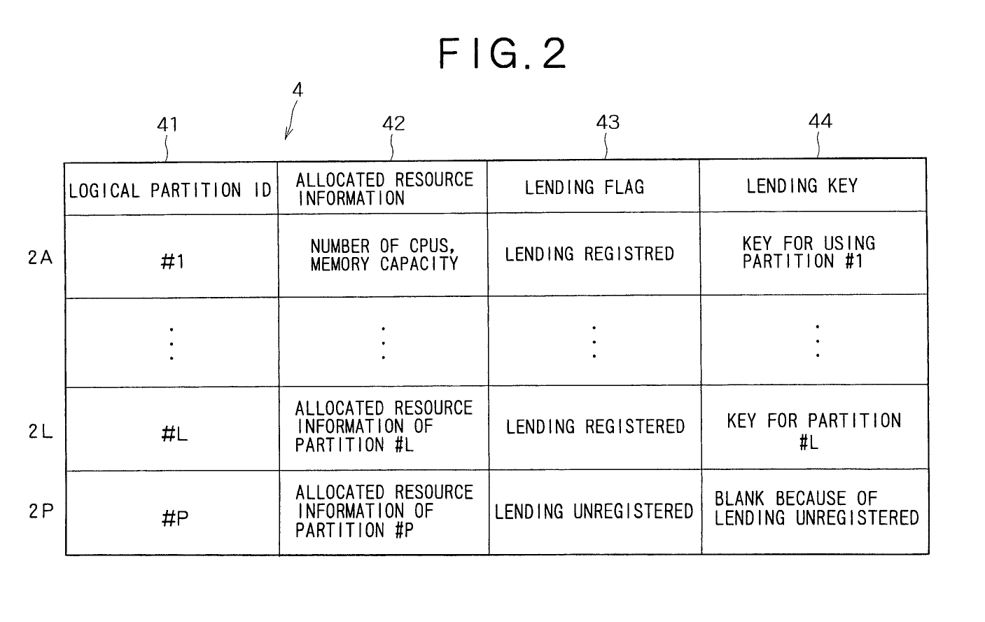

The data structure of the logical partition management database, as shown in FIG. 2, comprises a logical partition ID (#1 to #L) 41 of the available lendable logical partition 2A to 2L, information about resources allocated to the lendable logical partitions 2A to 2L and a non-lendable logical partition 2P (allocated resource information 42), a lending key 44 for authenticating the client system 2a (described later) and determining IDs of lendable logical partitions 2A to 2L that have been requested for lending, and a lending flag 43 as information for identifying lending registrations of the lendable logical partitions 2A to 2L (registration requests) made to the management server 10 (or identifying whether they are being lent or not).

The allocated resource information 42 comprises information including the types and number of CPUs, the upper limit of performance (or processing capability) that can be allocated, the upper limit of resources that can be provided, such as memory space and hard disk space, and available OSs.

The lending flag 43 indicates “lending registered” after the management server 10 has received notification of lending, or otherwise, indicates “lending unregistered”.

A lending key 44 is set for each of the lendable logical partitions 2A to 2L and is not set for the non-lendable logical partition 2P that is not available to other computers.

The management server 10, which is attached to the network 30, stores information about lendable logical partitions of the lending servers 1a to 1n, searches for a lending server and a lendable logical partition that meet the requirements of a borrowing request (a request to use) from one of the client systems 20a to 20m, and if there is a logical partition meeting the requirements, lends the lending key to that one of the client systems 20a to 20m, thereby marketing computer resources.

The management server 10 mainly comprises a resource database 12 that stores information about the lendable logical partitions 2A to 2L of each of the lending servers 1a to 1n, a control unit 11 (control means) that performs processing responding to the lending registration from the lending servers 1a to 1n, and borrowing requests or searching requests from the client systems 20a to 20m, and a billing information database 13 that calculates the bill for the lending of resources the client systems 20a to 20m have used and the consideration to be paid to the lending servers 1a to 1n and stores the results.

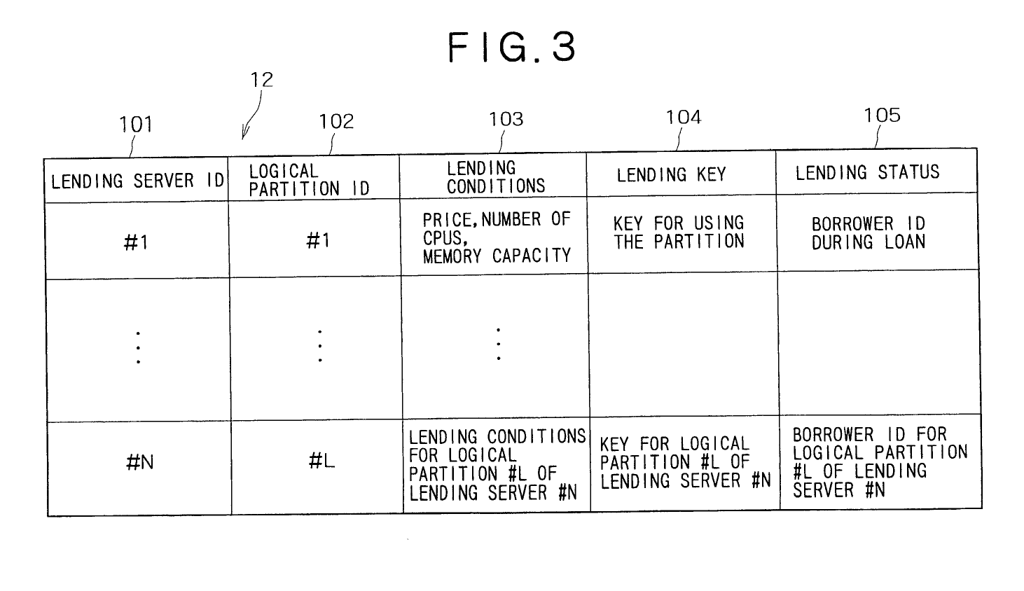

The data structure of the resource database 12, shown in FIG. 3, in which information based on registration requests from the lending servers 1a to 1n is stored, comprises a lending server ID 101 (#1 to #N) of the lending servers 1a to 1n, a logical partition ID 102 (#1 to #L) of the lendable logical partitions 2A to 2L that are set (or can be set) for each lending server, lending conditions 103 that are set for each lendable logical partition, a lending key 104 for each lendable logical partition, and the lending status 105 of each lendable logical partition.

The lending server ID 101 is a field that comprises, for example, information such as IP addresses and MAC addresses by NIC as information by which lending servers can be identified. The logical partition ID 102 is a field that stores information that identifies logical partitions set for each lending server.

The lending conditions 103 include information (upper limit of CPU processing capability, memory amount, and hard disk space) that is stored in the allocated resource information 42 of the logical partition management database 4 in each of the lending servers 1a to 1n, and rate information such as the lending charge per unit time.

The lending key 104 is used for authentication when the associated logical partition is used, and comprises, in the resource database 12, for example, information by which a lending server ID 101 and a logical partition ID 102 can be identified.

The lending status 105 is a field that stores the ID (#1 to #M) of one of the client systems 20a to 20m if the logical partition is being used thereby, and remains empty if the logical partition is not being used.

The client systems 20a to 20m that use the lendable logical partitions 2A to 2L of the lending servers 1a to 1n request borrowing of the resources from the management server 10 and the lending servers 1a to 1n; each comprises a user interface control unit 25 for submitting jobs to the lending servers 1a to 1n.

The OSs running on the client systems 20a to 20m need not be of the same type; any type of OS may be used.

2. System overview

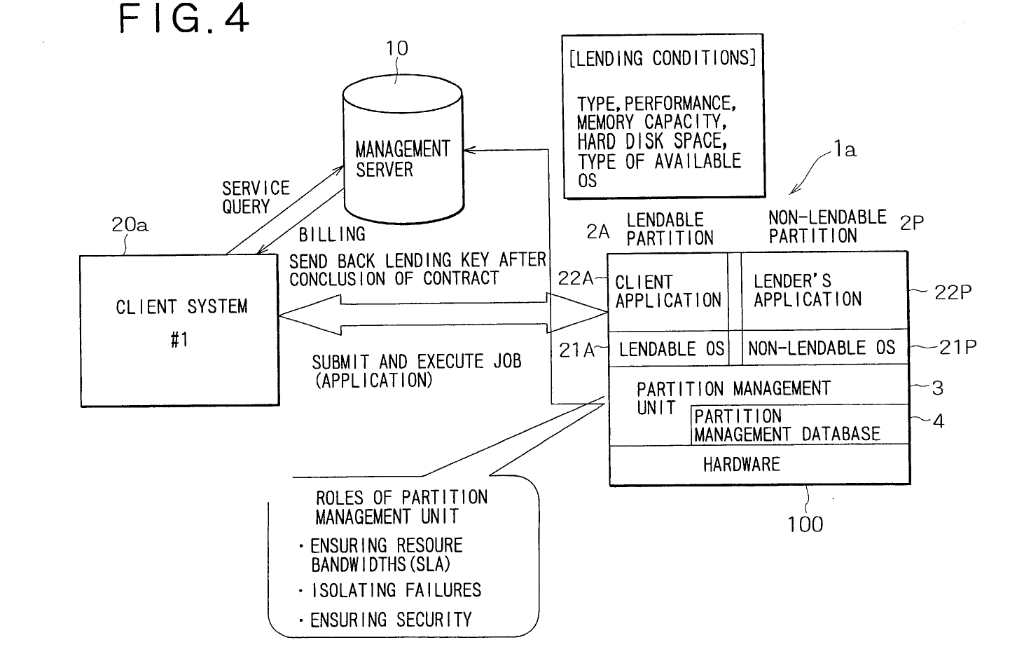

An overview of the resource marketing system using the management server 10, the lending server 1a, and the client system 20a will now be described with reference to the schematic drawing in FIG. 4.

In the lending server 1a, a non-lendable OS (such as an OS of the owner of the computer) 21P and a lender's application 22P are running on the non-lendable logical partition 2P (refer to FIGS. 1 and 2); the partition control unit 3, when there are spare resources or according to a command from a server manager, references the logical partition management database 4, and request the management server 10 to register information on available lendable logical partition 2A; the management server 10 registers the information.

The client system 20a sends a request to borrow (use) a logical partition on given conditions to the management server 10; then the management server 10 searches the resource database 12 based on the borrowing request conditions; if the contents of the lending conditions 103 of the lendable logical partition 2A in the lending server 1a meet the use requirements of the request and the lending status field 105 is blank, indicating that the partition is not in use, the management server 10 sends the allocated resource information determined from the lending server ID 101, the logical partition ID 102, and the lending key 104 or the lending conditions 103 in the resource database 12 to the client system 20a, whereby the borrowing contract is concluded.

After the contract is concluded, the client system 20a sends the lending key 104, lendable logical partition ID 102 (in this case #1), and allocated resource information (lending conditions 103) to the lending server 1a to request borrowing of the lendable logical partition 2A.

Then, the lending server 1a checks the lending key 104, lendable logical partition ID 102, and allocated resource information that have been sent against the corresponding information of the lending key 44 and other items stored in the logical partition database 4 for certification. This certification can also be carried out only with the lending key 104. The minimum information required for certification (certification information) is the lending key 104, but preferably, certification should be carried out using the lending key 104, the lending server ID 101, the logical partition ID 102, and the allocated resource information (lending conditions 103).

After the certification, the logical partition control unit 3 divides or generates the lendable logical partition 2A, and then starts an OS according to the borrowing request from the client system 20a; the lending interface control unit 5 executes a job (application 22A) submitted by the client system 20a.

The logical partition control unit 3, at least while the lendable logical partition 2A is provided to the client system 20a, locks the logical partition, forbids the supervisor (a system administrator or personnel with highest authorization) of the lending server 1a to change the logical partition while it is being lent, and disables alteration of resources that have been allocated to the lendable logical partition, thereby assuring the quality of resources to be provided, or their processing capability (or computing power). A lendable logical partition may be locked after the lending is registered in the management server 10.

Since the lendable logical partition 2A generated on the lending server 1a starts running a lending-dependent OS 21A, and this OS runs in a logical partition different from the non-lendable logical partition 2P in which OS 21P running in, even if one of these two OSs or one of its applications hangs up, the other OS can continue executing its own applications without being affected; and even if the client application 22A and other applications of the lendable logical partition 2A are infected with computer viruses and worms, the OS 21P and lender's application 22P of the non-lendable logical partition 2P cannot be affected by them, whereby adequate security on both lending and borrowing sides of the logical partitions can be provided.

On completion of the job from the client system 20a, the logical partition control 3 notifies the client system 20a of the completion of the job; the client system 20a notifies the management server 10 of the termination of the lending of the resource.

When the client system 20a terminates the loan, the management server 10 restores the lending status 105 in the resource database 12 to blank, stores lending charge based on the rate information in the lending conditions in the billing information database 13, charges the client system 20a (or the owner thereof and other persons) for using the resources, and pays the lending server 1a (or the owner thereof) a consideration for the loan.

3. Details of the system

The details of resource marketing performed by the management server 10, the lending server 1a, and the client system 20a will now be described below.

3-1 Process of generating lendable logical partitions in a lending server

The lending servers 1a to 1n generate lendable logical partitions 2A to 2L based on borrowing requests from the client systems 20a to 20m, and allocated them to the client systems. The lendable logical partitions 2A to 2L are dynamically changed by the logical partition control unit 31 so they do not always exist.

Therefore, if there is a requested logical partition among the lendable logical partitions 2A to 2L, the lending key 44 is checked against the lending key 104, then the logical partition is allocated; if there is not a requested logical partition among the lendable logical partitions 2A to 2L, it is generated.

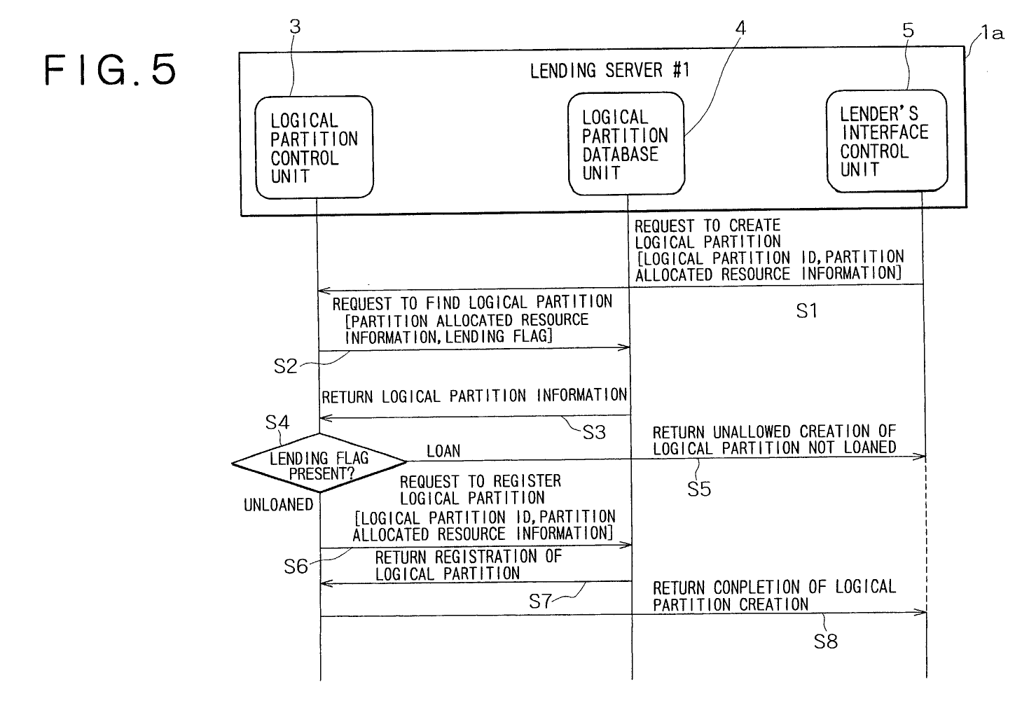

A process of generating lendable logical partitions 2A to 2L that is carried out in the lending server 1a will be described with reference to the flow diagram in FIG. 5.

FIG. 5 shows a process flow in the lending server 1a from acceptance of borrowing requests from the client systems 20a to 20m to generation and allocation of the lendable logical partitions.

The lending server, on reception of a borrowing request from the client system 20a at the lender's interface control unit 5, sends the logical partition ID 102, allocated resource information, and the lending key 104 that have been received from the client system 20a to the logical partition control unit 3 (Step S1).

The logical partition control unit 3 obtains the lending flag 43 indicating use of a lendable logical partition associated with the logical partition ID 102 that has been sent to the logical partition database unit 4 and allocated resource information 42 (Steps S2 and S3).

Next, the logical partition control 3 determines whether the lendable logical partition concerned is unallocated or on loan (Step S4).

If the lendable logical partition concerned is already lent or the lending key 104 does not match, the logical partition control unit 3 notifies the lender's interface control unit 5 of being unable to generate the lendable logical partition.

If the lendable logical partition concerned is not in use, and the lending key 104 received from the client system 20a matches the lending key 44 in the logical partition database 4, the logical partition control unit 3 allocates the lendable logical partition for lending to the client system 20a.

If the lendable logical partition concerned does not exist, the logical partition control unit 3 generates a lendable logical partition based on the allocated resource information 42, and, if the resources allocated to the non-lendable logical partition 2P are insufficient, it requests the logical partition database 4 to alter the contents of the allocated resource information 42 (Steps S6 and S7)

On completion of generation and allocation of the lendable logical partition, the logical partition control unit 3 notifies the lender's interface control unit 5 (Step S8).

After notification in Step S8, the lender's interface control unit 5 waits for a job (application 22A shown in FIG. 4) to be submitted.

3-2 Process of registering a new lendable logical partition in the management server

The contents of the resource database 12 in the management server 10 is generated, updated, or deleted based on a registration request from the lending server 1a to 1n, in which the resource information of the lendable logical partition determined by the lending server is stored.

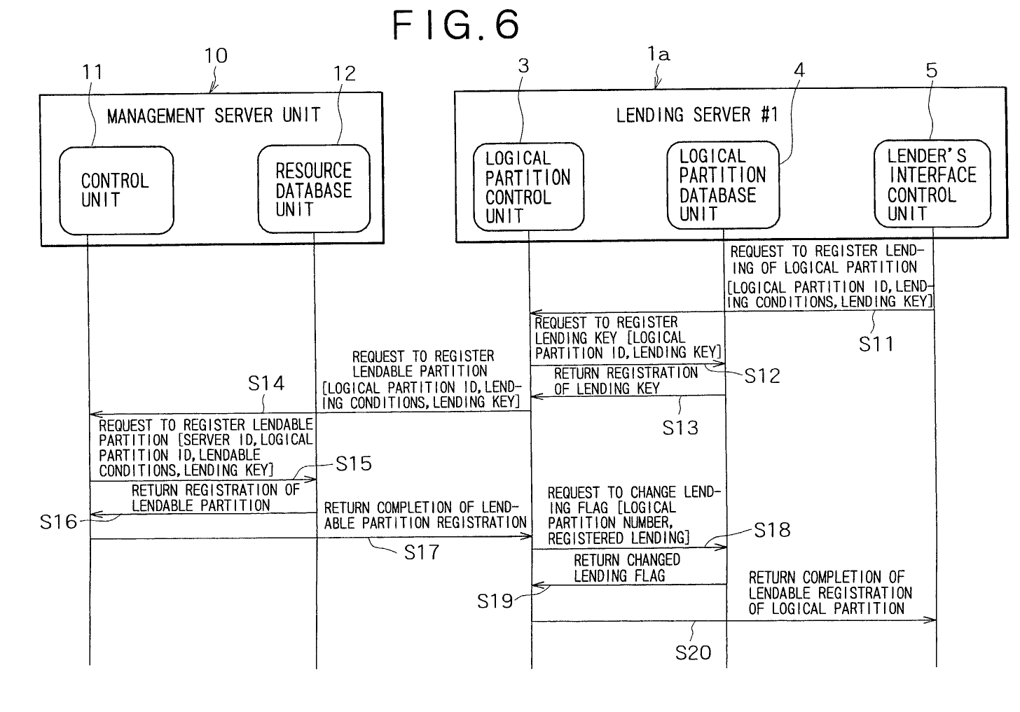

The flow of registration in the resource database 12 will be described with reference to the flow diagram in FIG. 6.

FIG. 6 shows the process of registering new lending resource information in the management server 10 by the lending server 1a.

Defining a logical partition of the lending server 1a as a new lendable logical partition to enable it to be used by the client systems 20a to 20m on the network 30 first requires registration in the management server 10.

Therefore, in the lending server 10, the lender's interface control unit 5 must request new lending registration of a logical partition to the logical partition control unit 3 (Step S11).

The lender's interface control unit 5 sends the logical partition control unit 3 the lending information comprising the lending conditions including the ID, allocated resource information, and charge information and lending key of the new lendable logical partition to be provided. The lending information comprises information set or entered by the administrator or other personnel of the lending server 1a.

On reception of this lending information, the logical partition control unit 3 requests the logical partition database 4 to register a new lendable logical partition, and writes the lendable logical partition ID 41, allocated resource information 42, and lending key 44 therein (Step S12 and S13).

On completion of the registration in the logical partition database 4, the logical partition control unit 3 requests the lending server 10 to register the new lendable logical partition, and sends information (lending registration information) comprising the server ID 101, ID of the lendable logical partition, lending conditions, and lending key thereto (Step S14).

On reception of the registration request from the lending server 1a, the control unit 11 of the management server 10 sends a command to write the ID of the lending server 1a and the received lending information registration into the resource database 12 (Step S15).

On completion of writing the new lending registration information, the resource database 12 notifies the control unit 11 of the completion of the registration (Step S16); the management server 10 notifies the lending server 1a of the completion of registration of the new lendable logical partition (Step S17).

On reception of this notification of the completion of registration, the lending server 1a requests the logical partition database unit 4 to set the lending flag 43 for the logical partition ID 41 the registration of which is requested from the logical partition control unit 3 (Step S18); the logical partition database unit 4 sets the lending flag 43 of the lendable logical partition concerned to “lending registered” (Step S19).

This lendable logical partition is locked starting from the time point when the lending flag 43 is set to “lending registered”.

On completion of the registration of the new lendable logical partition to the logical partition database 4, the logical partition control unit 3 notifies the lender's interface control unit 5 of the completion of the registration, and terminates the process (Step S20).

3-3 Process of altering registered information of a lendable logical partition

When the lending server 1a changes the providable lendable logical partitions, it must always change the contents of the resource database 12 of the management server 10. This is because, if the performance of the lendable logical partitions of the lending server 1a differs from the information of lending conditions stored in the resource database 12, it becomes impossible to assure the performance of the lendable logical partitions for the client systems 20a to 20m using them.

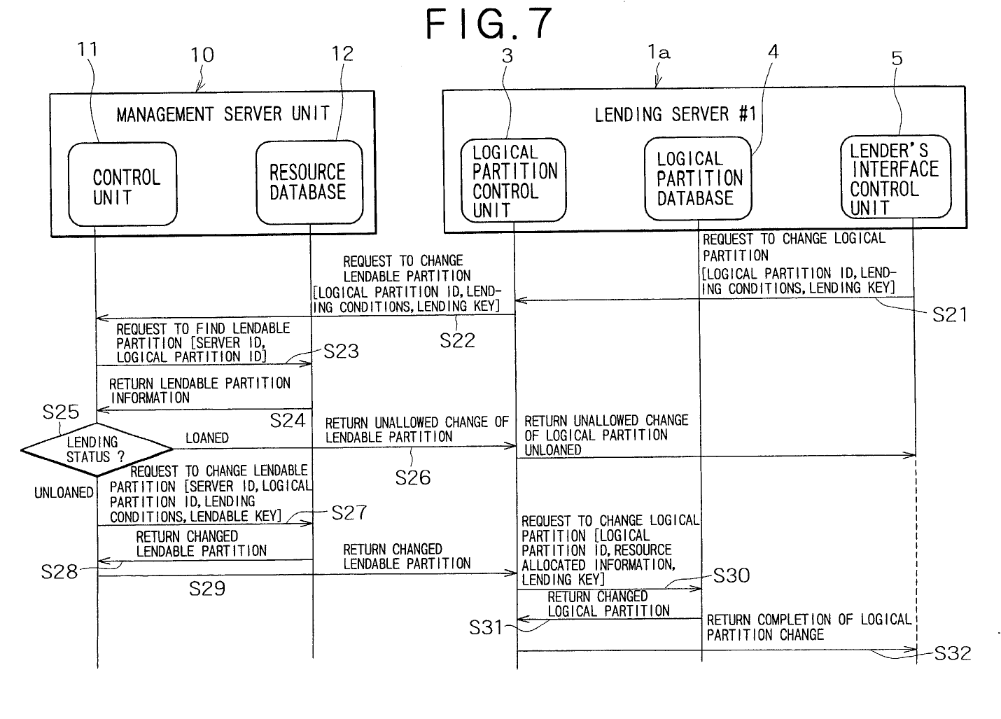

The flow of a process of altering the registered information of the lendable logical partition will be described with reference to the flow diagram in FIG. 7.

FIG. 7 shows a process of altering the information about a lendable logical partition registered to the management server 10 by the lending server 1a.

To alter the information about a logical partition of the lending server that has been registered in the resource database 12 of the management server 10, the information to be altered, comprising the logical partition ID 41, the allocated resource information 42, the lending conditions including charge information, and the lending key 44 of the logical partition concerned, is sent from the lender's interface control unit 5 to the logical partition control unit 3 (Step S21). The information to be altered is set or entered by the administrator or other personnel of the lending server 1a.

On reception of the information to be altered, the logical partition control unit 3 notifies the management server 10 of the alteration request for the lendable logical partition, and sends the new logical partition ID, lending conditions, lending key, and server ID 101 to the management server 10 (Step S22).

The control unit 11 of the management server 10 searches the resource database 12 based on the received alteration request, server ID 101, and logical partition ID for the current lending status 105 to determine whether the logical partition is being lent or not (Steps S23 and S24).

If one of the IDs of the client systems 20a to 20m has been stored in the lending status 105, the lendable logical partition concerned is being used, so the control unit 11 notifies the logical partition control unit 3 that the contents of the lending conditions 103 and other items cannot be altered; the logical partition control unit 3 sends the response from the management server 10 to the lender's interface control unit 5 (Steps S25 and S26).

On the contrary, if the field of the lending status 105 concerned is blank, the lendable logical partition is not in use, so the control unit 11 alters (updates) the information of the logical partition ID 102, lending conditions 103, and lending key 104 in the resource database 12 according to the altering information received from the lending server 1a (Steps S27 and S28).

On completion of alteration of the resource database 12, the control unit 11 of the management server 10 notifies the lending server 1a that the alteration has been completed (Step S29).

On reception of the completion of the alteration of the resource database 12, the logical partition control unit 3 of the lending server 1a alters the information of the logical partition ID 41, allocated resource information 42, and lending key 44, and after the completion of this alteration, notifies the lender's interface control unit 5 of the completion of the alteration and terminates the process (Steps S30 to S32).

3-4 Process of concluding a borrowing contract with a client system

In order to borrow the resources of the lending server 1a, the client systems 20a to 20m must first make a query about the available lending server 1a and the lendable logical partitions thereof, and if there is a resource meeting its requirements, make a borrowing contract and obtain the lending key.

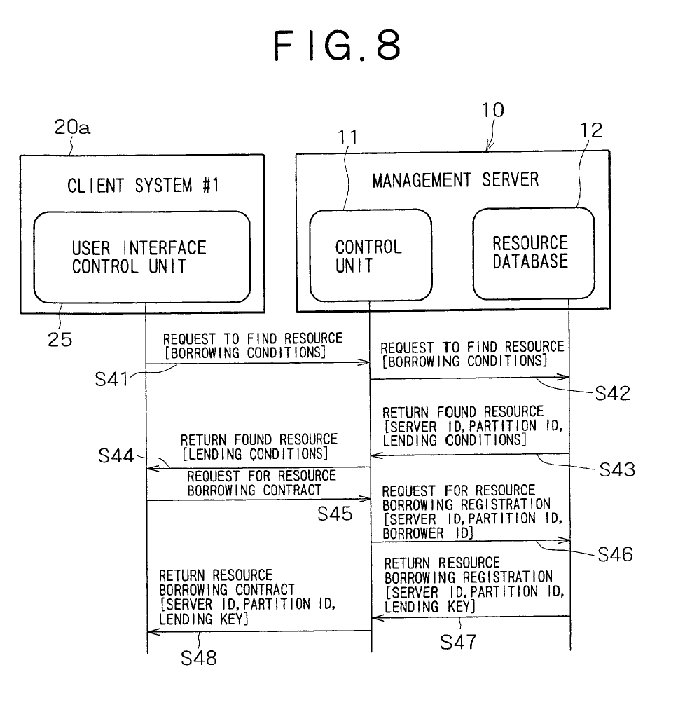

The process of concluding a borrowing contract with a client system will be described with reference to the flow diagram in FIG. 8.

FIG. 8 shows an example of a borrowing contract concluded between client system 20a and the management server 10.

The client system 20a exchanges data with the management server 10 via the user interface control unit 25. First, it sends borrowing requirements comprising required performance (required processing capability) and rate information of a desired resource to the management server 10 (Step S41). The borrowing requirements are previously set or entered.

On reception of the borrowing requirements, the control unit 11 of the management server 11 searches the resource database 12 for a logical partition that meets the borrowing requirements, obtains the lending conditions for the logical partition (Step S42 and S43), and sends the search result to the client system 20a (Step S44).

The client system 20a borrows resources based on the received lending conditions 103 by making a borrowing contract request to the management server 10 (Step S45).

Responding to the resource borrowing contract request, the control unit 11 of the management server 10 sends a request to borrow the intended logical partition to the resource database 12 by using the lending server ID, lendable logical partition ID, and ID of the client system 20a obtained in Step S43 as the borrower ID; the resource database 12 stores the borrower ID in the lending status 105 field, and passes the lending key 104 associated with the lending server ID and lendable logical partition ID to the control unit 11 (Step S46 and S47).

The control unit 11 sends the lending server ID, lendable logical partition ID, and lending key 104 to the client system 20a, whereby the borrowing contract is concluded (Step S48).

The management server 10 stores the time when the lending server ID, lendable logical partition ID, and lending key 104 are sent to the client system 20a, or the time when the borrowing contract is concluded, and sets this time as a starting time for computing charges to (use by) the client system 20a based on the rate information.

3-5 Job submission by client systems

On conclusion of the borrowing contract in Step S48, the client system 20a becomes able to execute a job (processing) using the borrowed resources defined by the lendable logical partition ID in the lending server ID that has been sent to it by the management server 10. On completion of the job, the client system 20a requests the management server 10 to delete the borrowing registration and terminates the borrowing contract.

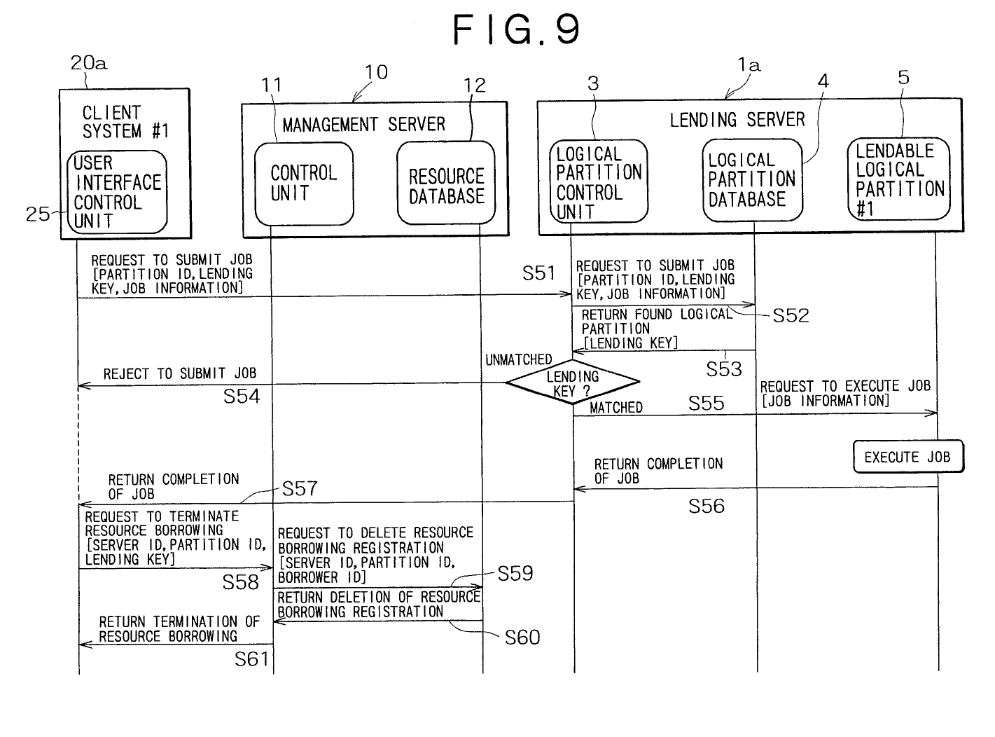

The flow of a process from submittal of the job to the end of resource borrowing, which is executed among the client system 20a, the lending server 1a, and the management server 10, will be described with reference to the flow diagram in FIG. 9.

The client system 20a is notified of the lendable logical partition 2A to be lent in the lending server 1a by the management server 10, and is given the associated lending key.

The client system 20a sends the lending server 1a a job submittal request comprising the logical partition ID, lending key 104, and job information (Step S51). The job information comprises, for example, the type of OS to be booted in the lendable logical partition 2A, and the types of applications to be executed.

In response to the job submittal request from the client system 20a, the logical partition control unit 3 of the lending server 1a determines whether the received lending key 104 matches the lending key 44 in the logical partition database 4 or not, and if the lending key 104 does not match the lending key 44, notifies the client system 20a that the job submittal request is rejected (Step S52 to S54).

If the lending key 104 and 44 match, the logical partition control unit 3 accepts the jog submittal request and executes the job from the client system 20a in the designated lendable logical partition 2A (Step S55).

On completion of the job, the lendable logical partition 2A notifies the logical partition control unit 3 that the job has been completed; the logical partition control unit 3 in turn notifies the client system 20a (Steps S56 and S57).

On reception of the notification of job completion, the client system 20a notifies the management server 10 of the termination of the borrowing contract (Step S58). Specifically, the notification of termination of the borrowing contract is made by sending the lending server ID, logical partition ID, and lending key to the management server 10.

The management server 10 receives this borrowing contract termination notification at the control unit 11, searches the resource database 12 with the ID of the client system 20a as the borrower ID and based on the received lending server ID, logical partition ID, and lending key, and deletes the borrower ID from lending status 105 in which it was stored during the loan (see FIG. 3) to indicate not-in-use status, thereby deleting the borrowing registration of the resource (Step S59 and S60).

The management server 10 notifies the client system 20a of the termination of the borrowing of the resource, thereby ending the series of resource marketing and borrowing processes (Step S61). On termination of the resource borrowing contract, the management server 10 sets the time point when the client system 20a sent the resource borrowing termination request as the end point of the time for calculating the charge (end point of use), calculates the charge from the starting point described above to the end point as billing information, and stores the result in the billing information database.

4 Actions

For simplification, the example described above uses a single lending server 1a and client system 20a, but the client systems include a plurality of computers as shown in FIG. 1.

The plurality of client systems 20a to 20m can borrow the plurality of lendable logical partitions 2A to 2L generated in the plurality of lending servers 1a to 1n by referencing the management server 10 that manages the lending resources to speedily identify available resources that meet the borrowing requirements, enabling quick acquisition of required performance and OSs in peer-to-peer computing in which resources are shared among a plurality of computers.

At least while the lendable logical partition 2A is being provided to the client system 20a, the logical partition control unit 3 of the lending server 1a to 1n that provides resources locks this logical partition, and disables alteration of this logical partition while it is being lent, by operations on the lending server side, thereby enabling the quality of resources to be provided, or the processing capability (or the computing capability or bandwidth), to be assured.

In the embodiment above, a lending server using a logical partition control unit 3 such as an LPAR or hypervisor unit generates lendable logical partitions and non-lendable logical partitions, so the lendable logical partition 2A to 2L are logical partitions different from the OS 21P of the non-lendable logical partition and an independent lending OS 21A is run thereon; consequently, if one of the applications or OSs hangs up, the other OS is not affected thereby and can continue executing applications, whereby fault tolerance can be improved; even if an application executed in one logical partition is infected by computer viruses or worms, OSs or the application P executed in other logical partitions cannot be infected, so adequate security can be provided for both the lenders and borrowers of the logical partitions; in peer-to-peer computing in which a plurality of client systems 20a to 20m share the use of logical partitions of a plurality of lending servers 1a to 1n, lending conditions can be assured, adequate fault tolerance and security can be provided, and higher quality services can be provided, thereby implementing resource marketing systems suitable for execution of mission-critical operations such as IDC (Internet Data Canter) and ASP (Application Service Provider).

In a preferred configuration, a plurality of logical partitions can each run a different OS, so the logical partitions do not affect each other. Therefore, if processing or an OS in one logical partition hangs up, processing in other logical partitions can be continued, and the services provided can be made fault tolerant. In addition, infection of computer viruses and worms among the logical partitions cannot occur, so it is possible to provide adequate security and a higher-quality resource marketing system.

The logical partition control means (the logical partition control unit 3) of a computer (lending server) that offers resources disables alteration of a logical partition, at least while the client is using the logical partition, so it becomes possible to prevent the logical partition from being altered by operations on the computer side while it is being lent, whereby the quality of resources provided, or the processing capability (or computing capability, or bandwidth), can be assured.

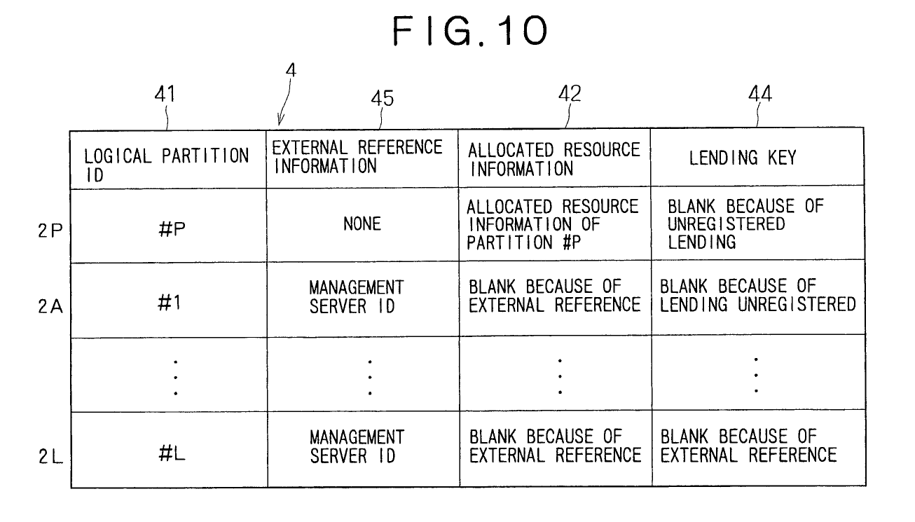

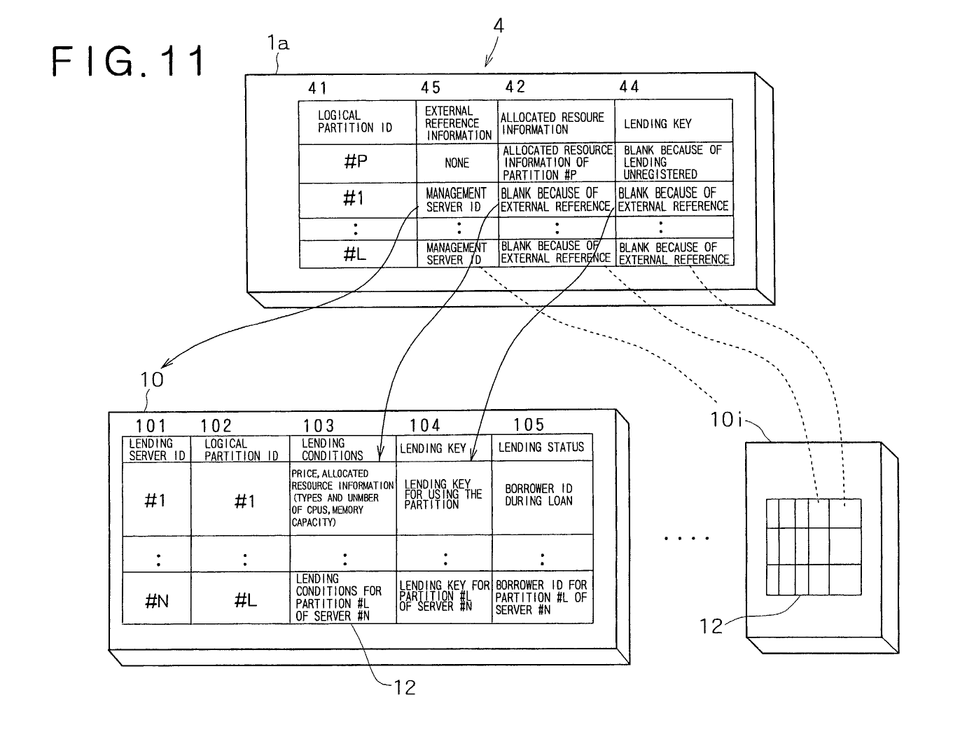

FIGS. 10 and 11 show a second embodiment of the invention, in which the hardware structure is the same as in the first embodiment of the invention, but the lending flag 43 of the logical partition database of the lending servers 1a to 1n that was used in the first embodiment of the invention is eliminated, while a field for external reference information 45 comprising externally referenced management server IDs is provided, thereby enabling the allocated resource information 42 of the lendable logical partitions (#1 to #L) to be referenced from a resource database 12 that is provided outside the lending server (in the management server 10), and enabling control of the allocated resource information 42 with the resource database 12 of the lending servers 10 to 10i for each lendable logical partition.

The logical partition database 4′ that manages logical partitions of each of the lending servers 1a to in comprises the following fields: a logical partition ID 41 (#1 to #P) that identifies logical partitions, the externally referenced information 45 that stores ID of any of the external management servers 10 to 10i to be referenced, the allocated resource information 42, and lending key 44.

In the logical partition database 4′, logical partitions the management server IDs of which are stored in the field of the externally referenced information 45 are handled as lendable logical partitions; at the same time, the allocated resource information 42 and lending key 44 are managed by the resource database 12 of the external management servers 10 to 10i.

Therefore, the fields of the allocated resource information 42 and lending key 44 associated with the lendable logical partitions 2A to 2L are left blank; the information is stored in the resource database of external management servers 10 to 10i designated by management server IDs in the fields of the externally referenced information 45.

While the first embodiment of the present invention makes a distinction between lendable logical partitions and non-lendable logical partitions depending on the information in the lending flags 43 stored in the logical partition database 4, the logical partition database 4′ can distinguish between them more easily by the presence or absence of the information of the externally referenced information 45.

On the other hand, in this embodiment, a logical partition with a blank field in the corresponding externally referenced information 45 is handled as a non-lendable logical partition; allocated resource information of a partition to be used thereby is stored in the allocated resource information 42; and since the logical partition is not being lent, the field of the lending key 45 has no reference information.

In this case, only the contents of the allocated resource information 42 for a lendable logical partition to be lent are placed on the management server 10 to 10i, whereby the allocated resource information to be lent is reliably prevented from being altered without being recognized by the management servers 10 to 10i, enabling further improvement of the quality of lending resources.

In addition, it becomes possible to control the operations of a plurality of lendable logical partitions on the management servers 10 to 10i; the management servers 10 to 10i can alter allocated resource information stored in the lending conditions 103 to suit market trends among the client systems 20a to 20m to quickly provide lending resources tailored to market needs. The allocated resource information can be altered, for example, by adjusting the balance of CPU performance, I/O performance, and memory performance of lendable logical partitions of the plurality of the lending servers 1a to 1n.

The relationships between the information of the logical partition database 4′ of the lending server 1a and the information stored in the resource database 12 of the management servers 10 to 10i will now be described with reference to FIG. 11.

In this drawing, the logical partition database 4′ of the lending server 1a stores logical partition IDs, these being the management server IDs associated with the logical partition IDs #1 to #L, in the fields of the externally referenced information 45, thereby indicating that these are lendable logical partitions.

On the other hand, the externally referenced information 45 associated with the logical partition with logical partition ID #P is left blank, indicating that this logical partition is a non-lending partition.

If the management server ID associated with logical partition ID #1 indicates management server 10, the content of the allocated resource information 42 and lending key 44 of lendable logical partition #1 (2A in FIG. 1) is stored in the lending conditions 103 and lending key 104 stored in the resource database 12 of the management server 10.

On the other hand, if the management server ID associated with logical partition ID #L indicates management server 10i, the content of the allocated resource information 42 and lending key 44 of #L lendable logical partition (2L in FIG. 1) is stored in the lending conditions 103 and lending key 104 stored in the resource database 12 of the management server 10i.

Therefore, when the logical partition control unit 3 of the lending server 1a generates a lendable logical partition with ID #1, it references the resource database 12 of the management server 10 based on the ID of the lending server 1a and logical partition ID (#1), and generates a lendable logical partition based on the allocated resource information stored in the lending conditions 103.

Similarly, when the logical partition control unit 3 of the lending server 1a generates a lendable logical partition with ID #1, it references the resource database 12 of the management server 10i based on the ID of the lending server 1a and logical partition ID (#1), and generates a lendable logical partition based on the allocated resource information stored in the lending conditions 103.

That is, the right to alter the allocated resource information to be generated rests with the management servers 10 to 10i; as described above, the management servers 10 to 10i can alter the lending conditions stored in the resource database 12 according to the needs of the client systems 20a to 20m, and can keep the lending resources of the plurality of lending servers 1a to 1n always optimized, thereby enabling more flexible resource marketing.

Specifically, the resource database 12 of the management servers 10 to 10i can alter resources of the lendable logical partitions 2A to 2L of the lending servers 1a to 1n in response to borrowing requests from the client system 20a to 20m, and alter information in the lending conditions 103 to meet the requirements of the client systems 20a to 20m.

The management servers 10 to 10i send lending server ID 101, logical partition ID 102, and lending key 104 to the client systems 20a to 20m; at the points of time at which the client systems 20a to 20m make borrowing requests to the lending server 10 to 10i, the lending servers 1a to 1n search the resource database 12 to alter the allocated resources of the lendable logical partitions; then lock the lendable logical partitions and accept jobs from the client systems 20a to 20m.

The lending server 1a generates a non-lendable logical partition #P for its own use based on the allocated resource information 42 stored in the logical partition database 4′ therein, so the non-lendable partition #P will not be affected by alteration of the allocated resources for lendable logical partitions made by the management servers 10 to 10i.

The details of resource marketing by the management server 10, the lending server 1a, and the client system 20a will now be described.

3-1b Process of generating lendable logical partitions in lending servers (the second embodiment)

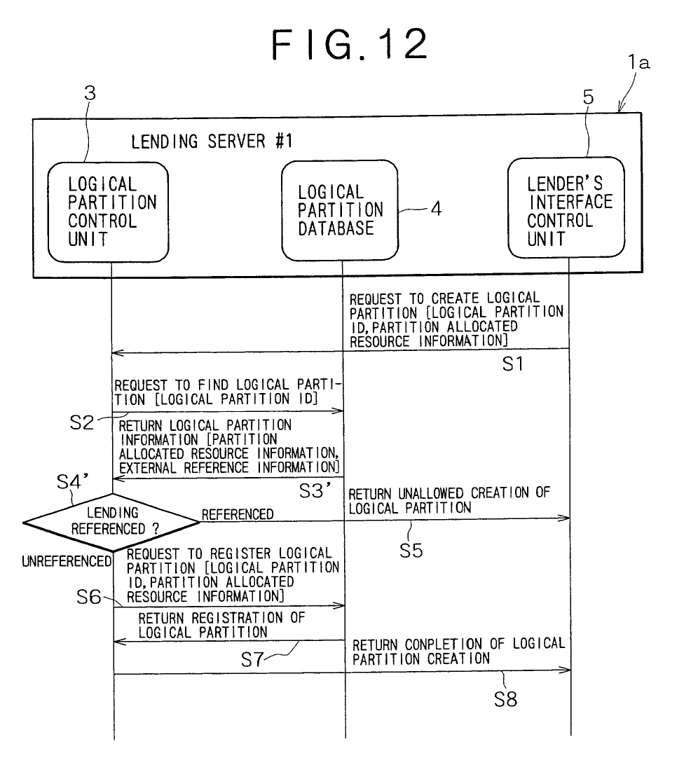

The process of generating the lendable logical partitions 2A to 2L performed in the lending server 1a will be described with reference to the flow diagram in FIG. 12.

FIG. 12 shows the flow of the process in the lending server 1a from the time of the reception of borrowing requests from the client systems 20a to 20m to the time of the generation and allocation of lendable logical partitions, in which processes similar to like processes in the first embodiment are indicated by like reference characters, and the descriptions thereof will be omitted.

Steps S1 and S2 of generation of lendable logical partitions are the same as in FIG. 5 for the first embodiment, but the operation of searching the logical partition database 4 in Step S3′ differs from that of Step S3 for the first embodiment.

Specifically, in Step S3′, the logical partition database 4 references the allocated resource information 42 and lending status from the lending condition 103 and lending status 105 in the resource database 12 of the management server 10, then responds to the logical partition control unit 3.

If the lending status 105 does not include a borrower client ID, indicating that the logical partition is not in use, the logical partition control unit 3 proceeds to Step S6′ to generate a lendable logical partition; while if the lending status 105 includes a borrower client ID, indicating that the logical partition is being used, the logical partition control unit 3 notifies the lender's interface control unit that a lendable logical partition cannot be generated.

The operation in Step S6′ differs from the first embodiment in that lendable logical partitions are generated by using allocated resource information 42 as the result of reference of the lending condition 103 of the resource database 12.

The other operations are the same as in the first embodiment.

3-2b Process of registering new lendable logical partitions in the management server (the second embodiment)

Generating new lendable logical partitions includes registration thereof in the resource database 12 of the management server 10 in response to registration requests from the lending servers 1a to 1n.

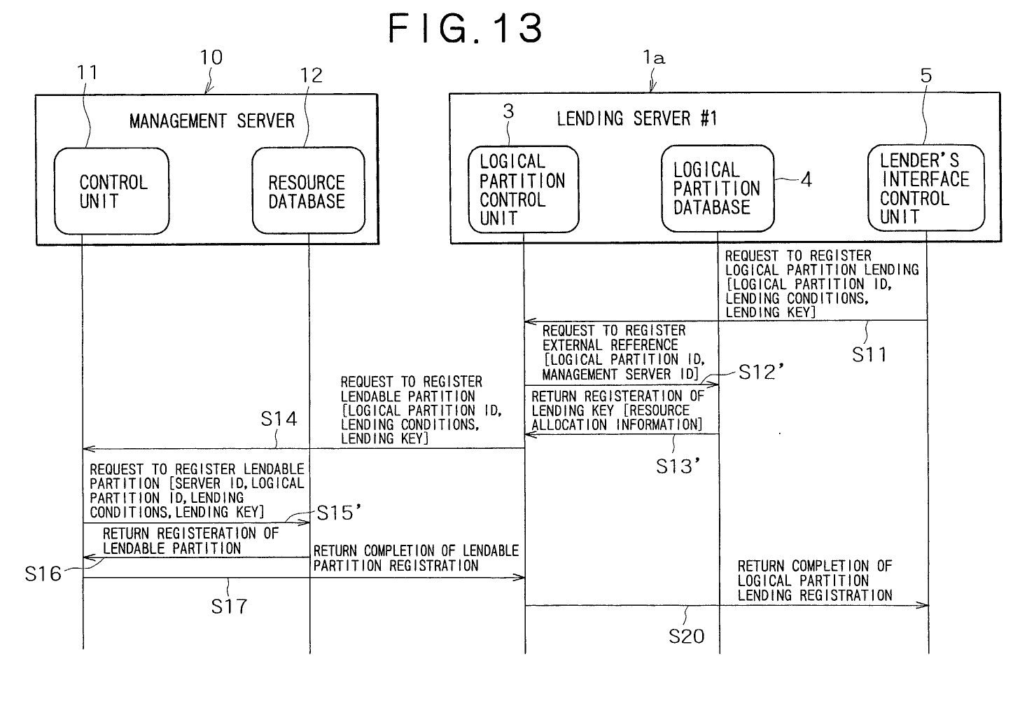

The flow of operations of registration in the resource database 12 will be described with reference to the flow diagram in FIG. 13.

FIG. 13 shows operations performed by the lending server 1a when registering lending resource information in the management server 10. Operations similar to the operations shown in FIG. 6 for the first embodiment are indicated by the same reference characters as in FIG. 6. The descriptions thereof will be omitted.

In Step S11, the lender's interface control unit 5 sends lending information such as a lendable logical partition ID, lending conditions including allocated resource information and rate information, and a lending key to the logical partition control unit 3, and requests new lending registration of a newly provided logical partition.

On reception of the lending information, the logical partition control unit 3 externally references the resource database of the management server 10 via the logical partition database 4, writes the externally referenced information 45 for registration of a new lendable logical partition into the logical partition database 4, and on completion of the writing thereof, notifies the logical partition control unit 3 (Steps S12′ and S13′).

In Step 14, as in Step 14 in FIG. 6 for the first embodiment, the logical partition control unit 3 makes a registration request to the control unit 10 of the management server 10; then the server ID, logical partition ID, lending conditions (allocated resource information 42), and lending key are registered in the resource database 12 (Step S15′). The second embodiment differs from the first embodiment in that the information of the lending conditions 103 including the allocated resource information 42 and the lending key 104 is stored in the resource database 12 and the logical partition database 4 of the management server 1a includes only referenced information thereof.

The other operations are the same as in the first embodiment shown in FIG. 6.

On completion of registration in the logical partition database 4, the logical partition control unit 3 requests new registration of a lendable logical partition to the control unit 11 in the management server 10, and sends information (lending registration information) comprising the server ID, ID of the logical partition for new lending, lending conditions, and lending key (Step S14).

On reception of a registration request from the lending server 1a at the control unit 11, the management server 10 sends a command to write the ID of the lending server 1a and the received lending registration information in the resource database 12 (Step S15).

The resource database 12 completes the writing of new lending registration information, and notifies the control unit 11 (Step S16); the management server 10 notifies the lending server 1a of the completion of new registration of the lendable logical partition (Step S17).

On reception of the notification of the completion of registration, the lending server 1a requests the logical partition database 4 to set the lending flag 43 corresponding to the logical partition ID 41 of the logical partition for which the logical partition control unit 3 made a registration request (Step S18); the logical partition database 4 sets the lending flag 43 of the lendable logical partition concerned to “lending registered” (Step S19).

From the point of time the lending flag 43 is set to “lending registered”, the lendable logical partition is kept locked.

On completion of registration in the logical partition database 4, the logical partition control unit 3 notifies the lender's interface control unit 5 of the completion of the new registration of the lendable logical partition, and terminates the operation (Step S20).

3-3b Process of altering the registered information of lendable logical partitions (the second embodiment)

The lending server 1a cannot alter information about lendable logical partitions to be provided by the lending server 1a without requesting alteration of the contents of the resource database 12 to the management server 10.

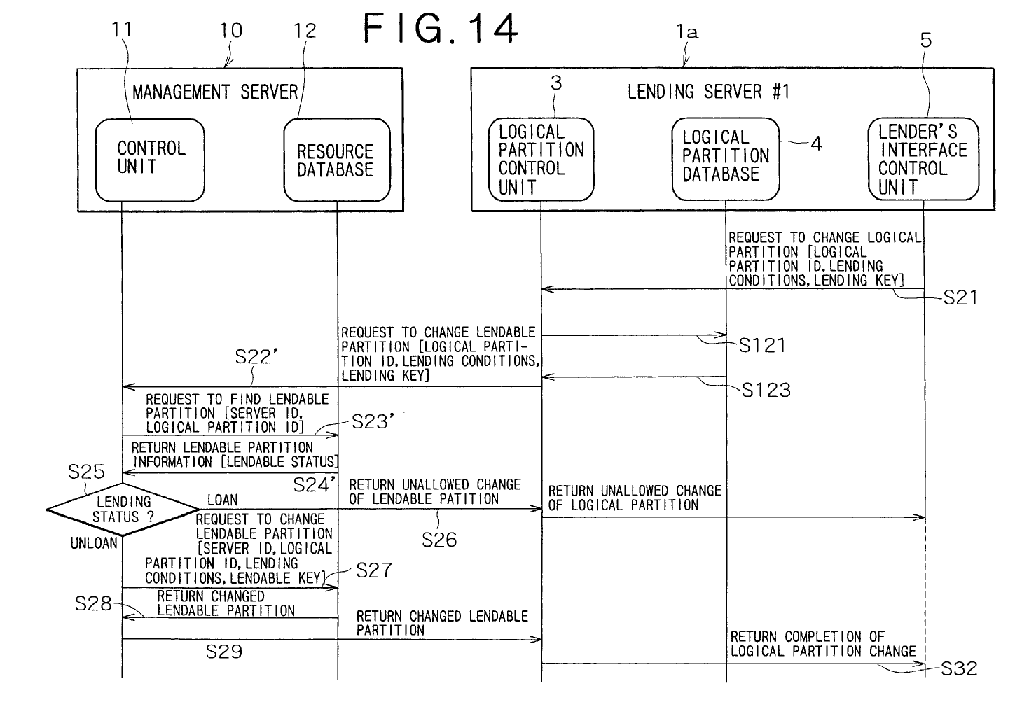

The flow of operations for altering the registered contents of the lendable logical partition to be provided will be described with reference to the flow diagram in FIG. 14.

In FIG. 14, operations similar to like operations in FIG. 7 for the first embodiment are indicated by like reference characters, and descriptions of them will be omitted.

In Step S21, the lender's interface control unit 5 sends the logical partition ID 41, and altered information about lending conditions comprising allocated resource information 42 and rate information and the lending key 44 to the logical partition control unit 3.

The logical partition control unit 3 queries the logical partition database 4 about a management server ID having allocated resource information 42 associated with the logical partition ID 41 of the logical partition concerned to (Step S122); the logical partition database 4 finds and returns the management server ID that references the allocated resource information 42 and lending key 44 associated with the logical partition ID of the logical partition concerned (Step S123).

The logical partition control unit 3 sends a request for alteration of the lendable logical partition to any of the management servers 10 to 10i having the ID concerned (Step S22′).

Subsequently, as in FIG. 7 of the first embodiment, the management server 10 alters the contents of the resource database 12, and on completion of the alteration, notifies the logical partition control unit 3 that the alteration has been completed (Step S23 to S29).

After that, the logical partition control unit 3 of the lending server 1a returns the completion of alteration to the lender's interface control unit 5 and terminates the operation (Step 32).

In this case, the difference from the operations in FIG. 7 of the first embodiment is that notification of the completion of alteration from the management server does not cause the contents of the logical partition database 4 to be updated; just the update of the resource database 12 for external reference completes the alteration of lendable logical partitions.

3-4b Process of concluding a borrowing contract with a client system (the second embodiment)

This process is the same as in the first embodiment, so a description will be omitted.

3-5b Submittal of jobs by client systems (the second embodiment)

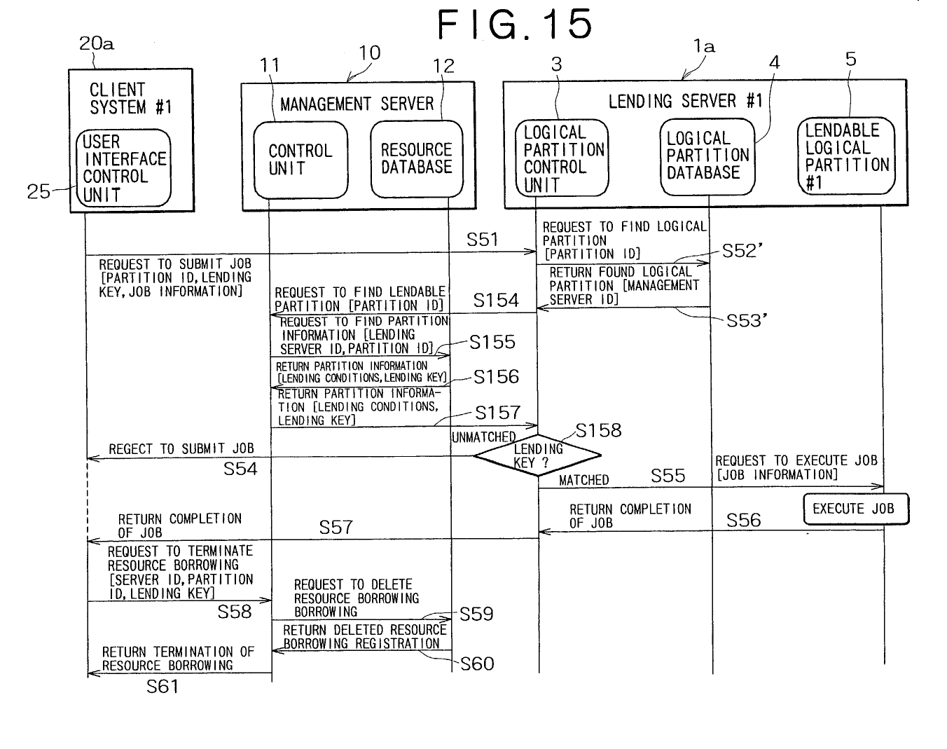

The flow of operations from submittal of jobs to termination of resource borrowing that are performed by the client system 20a, lending server 1a, and management server 10 will be described with reference to the flow diagram in FIG. 15. In FIG. 15, operations similar to like operations in FIG. 9 for the first embodiment are indicated by like reference characters, the descriptions thereof will be omitted.

The client system 20a sends a job submittal request comprising a logical partition ID, lending key 104, and job information to the lending server 1a (Step S51).

The logical partition control unit 3 of the lending server 1a searches the logical partition database 4 for the received logical partition ID based on the job submittal request from the client system 20a, and obtains the management server ID that manages the information about the logical partition (Step S52′ and S53′).

Next, the logical partition control unit 3 reports the lending server ID and the logical partition ID to the control unit 11 of the management server 10, and requests that the lending key 104 be stored in the resource database 12 (Step S154 to S156).

The control unit 11 sends the lending key 104 from the resource database 12 to the logical partition control unit 3 (Step S157), which performs certification of the lending key sent from the client system 20a and the lending key 104 sent from the control unit 11 of the management server 10 (Step S158). The subsequent operations are the same as in the first embodiment: after the certification, the client system 20a submits a job (application); on completion thereof, resource borrowing registration is deleted, whereby use of the lendable logical partition of the lending server 1a is terminated.

As described above, when a plurality of client systems 20a to 20m borrow a plurality of lendable logical partitions #1 to #L generated in a plurality of lending servers 1a to 1n, both the lending servers and client systems can reference the management servers 10 to 10i, and the management servers 10 to 10i can alter the allocated information 42 of the lending conditions 103, so it is possible to adjust the balance of the lending resources to market demands, and thereby to quickly provide the borrower client systems 20a to 20m with resources that meet their borrowing requirements, enabling quick acquisition of required performance and OSs in peer-to-peer computing that shares resources among a plurality of computers.

In addition, the logical partition control unit 3 (logical partition control means) of a computer that lends the resources alters the logical partitions by referencing the allocated resource information 42 stored in the external resource database 12, whereby arbitrary alteration of the lendable logical partition can be prevented in the lending servers (computers) 1a to 1n, resulting in reliably assured processing capability (bandwidths) for borrower client systems.

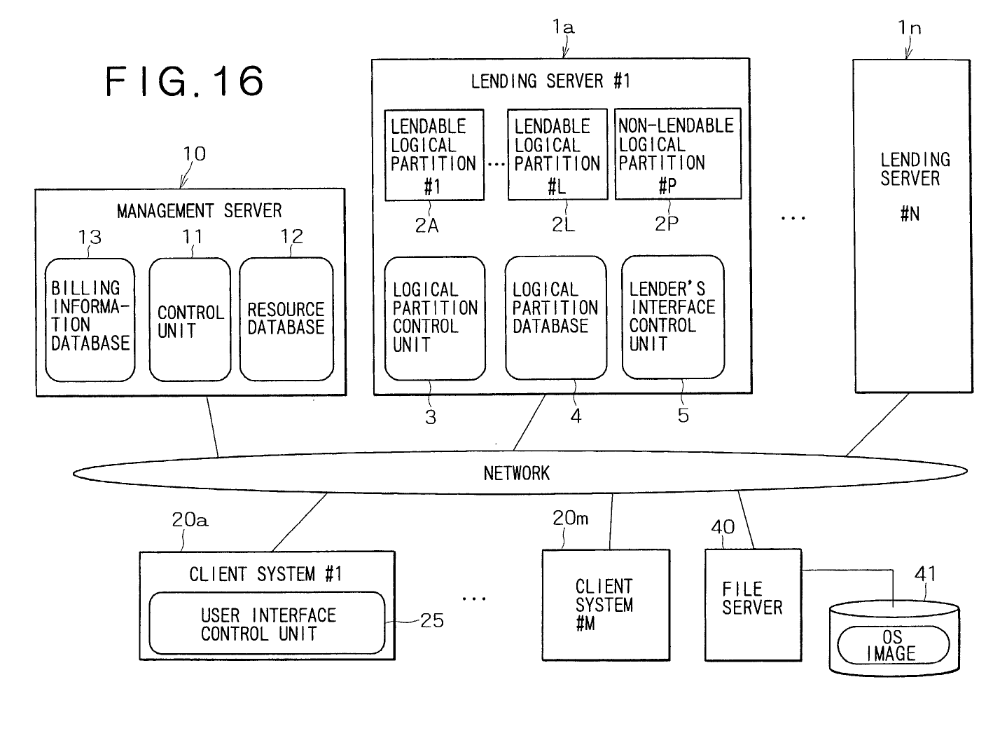

FIG. 16 shows a third embodiment, which has a network 30 as in the first and second embodiments and comprises a file server 50 that stores a plurality of OS images 51.

The lending server 1a to 1n, on establishment of given lending conditions, starts the OSs requested by the client systems 20a to 20m in the lendable logical partitions.

At this time, if the lending servers 1a to 1n lack the requested OSs, it opens the OS image 51 from the file server 50, and starts the OSs through the network 30 (so-called network boot).

Therefore, it eliminates the need for the lending servers 1a to 1n to store the OSs to be lent to the client systems, and enables the OS images 51 to be run by network booting.

This eliminates the need for the management server 10, when searching for lending servers 1a to 1n on requests from the client systems 20a to 20m for allocation, to take the type of OS into consideration, making the operations from reception of borrowing requests by client systems to conclusion of borrowing contracts faster, and it becomes possible for the lending servers 1a to 1n to provide lendable logical partitions regardless of OS types, making it possible to provide client systems with more suitable resources.

In the first embodiment described above, the client systems 20a to 20m determine resources to borrow through the management server 10; if the network 30 is a LAN or a WAN and the lendable logical partitions are provided without charge within an organization, the client system 20a or other system may directly references the logical partition database 4 of the lending server 1a to 1n, and use available lendable logical partitions among those stored therein.

In this case, the client systems 20a to 20m should previously obtain the lending keys of the lending servers 1a to 1n they intend to use.

Although the first embodiment uses a management server 10 in which the control unit 11 and resource database 12 are included, the control unit 11 and resource database 12 may be run on different computers.

It is to be understood that the embodiments described herein are illustrative in every point and not restrictive. The scope of the invention is defined by the appended claims rather than by the preceding description, and all variations that fall within the bounds of the claims, or are equivalent subject matter within those bounds, are therefore intended to be embraced by the claims.

What is claimed is:

1. A computer resource marketing system comprising:
a computer with a logical partition control means for dividing resources of the computer into a plurality of logical partitions and designating at least one logical partition to be as lendable;
a client system that requests use of the resources of the computer and submits processing to the computer;
a resource database storing lending conditions and certification information of the logical partitions of the computer; and
a management means that searches the resource database according to use requirements defined by the client system, finds a logical partition that meets the use requirements, notifies the client system of the logical partition found by the search, and grants the client system permission to use the logical partition.

2. The computer resource marketing system of claim 1, wherein the logical partition control means has allocation information indicating resources that have been allocated to the logical partitions of the computer, and comprises an altering means for changing logical partitions according to the allocation information, and a means for disabling change of the logical partition while the client is using it.

3. The computer resource marketing system of claim 1, wherein:
the resource database has allocation information that indicates resources allocated to the logical partitions of the computer;
the logical partition control means has a alteration means for changing logical partitions according to the allocation information of the resource database; and
the management means changes the allocation information according to the use requirements defined by the client.

4. The computer resource marketing system of claim 3, wherein the management means disables change of the allocation information of the resource database corresponding to the pertinent logical partition while the logical partition is being used.

5. The computer resource marketing system of claim 1, wherein different operating systems are bootable in the plurality of logical partitions.

6. The computer resource marketing system of claim 5, wherein the operating systems are stored in a file server linked to the computer, and the logical partition control means causes one of the operating systems meeting the defined use requirements to be booted in the logical partitions used by the client system.

7. The computer resource marketing system of claim 1, further comprising a billing information computing means for computing billing information according to use of the logical partitions by the client system.

8. A computer resource marketing method for a computer system configured by interconnection of:
at least one computer having resources divided into a plurality of logical partitions, at least one of the logical partitions being available for lending;
a client system that requests use of the resources of the computer and submits processing to the computer;
a resource database storing lending conditions and certification information of the logical partitions for each said computer; and
a management means for searching the resource database according to use requirements defined by the client system; the method comprising steps of:
searching the resource database, on reception of use requirements from the client system, for a computer with lending conditions that meet the use requirements;
notifying the client system, based on the search result, of certification information of a computer that meets the use requirements;
submitting processing from the client system to a logical partition of the computer of which the client system was notified; and
disabling change of allocation information associated with said logical partition at least while said logical partition is being used by the client system.

9. The computer resource marketing method of claim 8, further comprising a step of changing the allocation information after the step of searching for a logical partition according to use requirements received from the client system, and a step of changing the logical partition according to the allocation information.

10. The computer resource marketing method of claim 8, further comprising a step of computing billing information for the computer that has been used by the client system.

11. A computer resource-marketing system comprising:
a resource database that stores information about logical partitions that have been set as resources of the computer;
a client system that can request use of resources of the computer and submit processing to the computer; and
a management server that searches the resource database based on use requirements defined by the client system and notifies the client system of an available logical partition.
